(19) United States
(12) Patent Application Publication
(10) Pub. No.: US 2010/0274936 A1
(43) Pub. Date: Oct. 28, 2010

(54) OSD IMAGE GENERATING METHOD IN KVM SWITCHES

(75) Inventor: Yi-Li Liu, DELTA (CA)

Correspondence Address: Chen Yoshimura LLP;Attention Ying Chen, 333 W. El Camino Real, Suite 380, Sunnyvale, CA, 94087, US

(73) Assignee: ATEN INTERNATIONAL CO., LTD., Taipei (TW)

(21) Appl. No.: 12/429,938

(22) Filed: Apr. 24, 2009

(51) Int. Cl. G06F 3/033; G06F 13/00; G06F 13/12

(52) U.S. Cl. 710/72; 710/316; 345/163; 345/168; 710/62

(57) ABSTRACT

A method for generating on-screen display (OSD) image in a keyboard, video, mouse (KVM) system that includes a KVM switch, a plurality of computers and one or more console systems connected to the KVM switch. The console system includes a console side processor. The KVM switch generates drawing commands (including various data) descriptive of OSD images, and transmits the drawing commands to the console side. The various data may include vector graphic data, text data, and bitmap image data, but it does not include a bitmap representing the entire OSD image. The console side processor processes the received drawing commands and generates images representative of the OSD images based on the drawing commands, and displays the OSD images on the monitor of the console system.

### BACKGROUND OF THE INVENTION

1. Field of the Invention

This invention relates to a method of generating on-screen display (OSD) images, such as OSD images in a keyboard, video, mouse (KVM) switch system.

2. Description of the Related Art

In a keyboard, video, mouse (KVM) switch system, generally shown in FIG. 1a, multiple computers 12 are connected to one or more user consoles 11 by a KVM switch 13. Each user console 11 includes a display device (monitor) 11a and user input devices such as a keyboard 11b and a mouse 11c. The KVM switch 13 allows each user console 11 to selectively connect to and control one of the multiple computers 12. When a user console 11 is connected to a selected computer 12, the video signals generated by the selected computer 12 is transmitted by the KVM switch 13 to the user console 11 and displayed on its monitor 11a, and user input signals generated by the keyboard 11b and mouse 11c of the user console are transmitted by the KVM switch 13 to the selected computer 12 to control it. Thus, the user console 11 can communicate with the selected computer 12 as if the user console is directly connected to that computer.

In addition to communicating with the selected computer 12, the user console 11 can communicate with and control the KVM switch 13. For example, the user using the user console 11 can log on to the KVM switch 13, change the settings of the KVM switch, select one of the multiple computers 12 to control, etc. The KVM switch 13 implements an on-screen display (OSD) system to assist the user in communicating with the KVM switch. The OSD system generates images such as menus for display on the monitor 11a of the user console 11, and the user uses the keyboard 11b or mouse 11c to generate input signals for the KVM switch 13 in response to the OSD display.

One conventional method of generating an OSD display involves the KVM switch 13 generating bitmap images, compressing the bitmap images, and sending the compressed bitmap images to the user console 11. A bit-map (or raster) image is one of the two or more graphic types (the other being vector). Bitmap-based images are comprised of pixels in a grid. Each pixel or “bit” in the image contains information about the color to be displayed. Bitmap images have a fixed resolution and cannot be resized without losing image quality. Common bitmap-based formats are JPEG, GIF, TIFF, PNG, PICT, and BMP. Most bitmap images can be converted to other bitmap-based formats very easily. Bitmap images tend to have much large file sizes than vector graphics and they are often compressed to reduce their size. Although many graphics formats are bitmap-based, bitmap (BMP) is also a graphic format. The user console 11 decompresses the bitmap images and displays them on the monitor 11a. In other words, the entire OSD image is generated as a bitmap image by the KVM switch 13. This OSD generating method requires a relatively large amount of bitmap image data to be transmitted to the console. In addition, calculating bitmap images of the OSD is executed by the KVM switch 13, which increases the burden of the processor on the KVM switch. Moreover, if the monitors for different user consoles have different properties such as resolution, the KVM switch has to generate different bitmap images for the different monitors.

In another conventional method of generating OSD displays, the KVM switch 13 generate OSD images and overlays them with video signal from the computer 12 and transmits the video signal to the console 11. Then console displays the video signals in the same way as the video signal from the computer 12 is normally displayed, whereby the OSD image is displayed on the console monitor. Most conventional KVM switch systems adopt this method for OSD display on local consoles (i.e. consoles located within a relatively short range from the KVM switch and connected by a dedicated connection). This method requires more memory resource for the KVM switch 13 if multiple consoles are present.

Some KVM system uses the console 11 to generate OSD images. The console 11 receives from the KVM switch 13 data regarding system configuration, such as username, network address, etc. The data does not specify the actual user interface that will be displayed on the console monitor, and the console creates the user interface for itself. After the user finishes the relevant operations, the console may send instructions to the KVM switch, such as instructions regarding user logon, and the KVM switch interprets and executes the instructions. This method requires the console to be adapted for the particular KVM switches it communicates with because different KVM switches may use different system data format, etc. The console can also be provided with the ability to communicate with multiple different KVM switches, but this increases the resource requirements for the console. Under this scheme, both the console 11 and the KVM switch 13 are involved communication for each instruction. This method is used in KVM systems where the console is connected to the KVM switch via CAT5 cables, as well as KVM systems where the console is connected to the KVM switch over a network such as the Internet (referred to as KVM over IP).

FIG. 1b illustrates a KVM system in which a number of remote consoles 11 are coupled to the KVM switch 13 via a network 10 and respective console-side devices 17. The network 10 may be a local area network (LAN), wide area network (WAN), the Internet, Ethernet, Intranet, etc. The console-side device 17 can be any computing device, such as a desktop computer. The remote console 11 and the console-side device 17 may also be integrated in a laptop computer. A local console 18 may also be connected to the KVM switch 13.

FIG. 1c illustrates a KVM system in which a number of consoles 11 located remotely are coupled to the KVM switch 13 via respective console modules 19 and respective CAT5 interfaces 19a. The console module 19 functions to transform video signals in differential mode form the KVM switch 13 to single end signals readable for the monitor 11a of the console 11.

The above OSD generating methods are also employed in general server-client systems (generally shown in FIG. 1d).

Vector graphics are used widely in image generation. A vector image is one of the two major graphic types (the other being bitmap). Vector graphics are made up of many individual objects. Each of these objects can be defined by mathematical statements and has individual properties assigned to it such as color, fill, and outline. Vector graphics are resolution independent because they can be output to the highest quality at any scale.

### SUMMARY OF THE INVENTION

The present invention is directed to a method for generating OSD images that substantially obviates one or more of the problems due to limitations and disadvantages of the related art.

An object of the present invention is to provide an improved method for generating OSD images displayed on a user console.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method implemented in a KVM switch system for generating an OSD image, the KVM switch system including a KVM switch and a user console connected to the switch, the user console including a monitor, the method including: the KVM switch transmitting drawing commands descriptive of OSD images to the user console; the user console processing the drawing commands received from the KVM switch to generate bitmap images for OSD; and the user console displaying the bitmap images for OSD on the monitor of the user console.

In another aspect, the present invention provides, in a KVM switch system including a KVM switch and a user console connected to the switch, a method implemented in the KVM switch, which includes: generating drawing commands descriptive of on-screen display (OSD) images; and transmitting the drawing commands to the user console.

In another aspect, the present invention provides, in a KVM switch system including a KVM switch and a user console connected to the switch, the user console including a monitor, a method implemented in the user console, which includes: receiving from the KVM switch drawing commands descriptive of OSD images; processing the received drawing commands to generate bitmap images for OSD; and displaying the bitmap images for OSD on the monitor of the user console.

It is to be understood that both the foregoing general description and the following detailed description are exemplary and explanatory and are intended to provide further explanation of the invention as claimed.

### BRIEF DESCRIPTION OF THE DRAWINGS

FIGS. 1a-1c schematically illustrate KVM switch systems in which embodiments of the present invention may be implemented.

FIG. 1d schematically illustrates a server-client system in which embodiments of the present invention may be implemented.

FIG. 2 illustrates an OSD image generating method according to an embodiment of the present invention.

FIGS. 3 and 4 further illustrate the OSD image generating method of FIG. 2.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

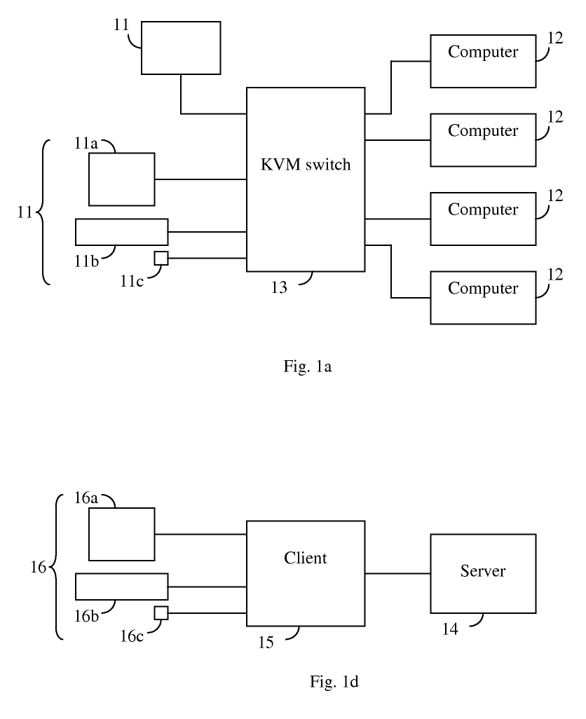

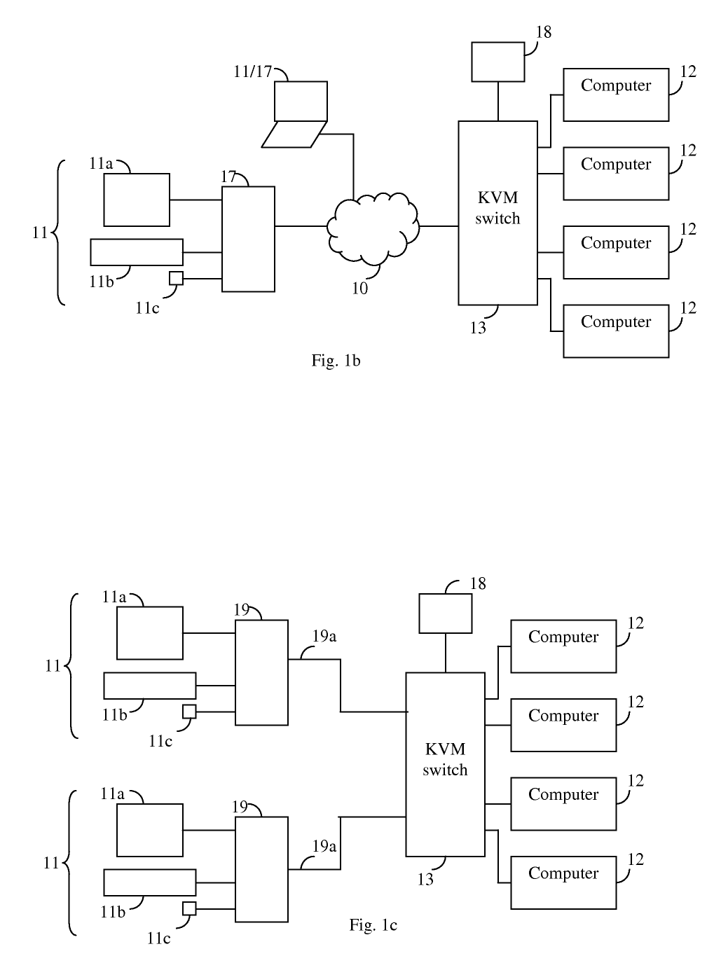

Embodiments of the present invention provide an improved method for generating OSD images for the user console in a keyboard, video, mouse (KVM) system. The KVM system in which the method can be implemented has the same general configuration as the ones shown in FIGS. 1a-1c, and the OSD generating method is implemented by software and/or firmware residing on the KVM switch 13 and the console side, for example, in the monitor 11a (FIGS. 1a-1c), in the console-side computer 17 (FIG. 1b), or the console module 19 (FIG. 1c). The console side has a processor to execute the software or firmware. The console side processor may be located in the monitor 11a (FIGS. 1a-1c), in the console-side computer 17 (FIG. 1c), or in the console module 19 (FIG. 1c); it may be implemented by any suitable structure, such as a microprocessor.

In this disclosure, the term “console side” or “console side system” generally refer to the user console 11 in the system of FIG. 1a, the collection of the user console 11 and the console-side device 17 in the system of FIG. 1b, or the collection of the user console 11 and the console module 19 in the system of FIG. 1c. The console side functions may be performed by any suitable part of the console side; for example, as stated above, the console side processor can be located anywhere on the console side.

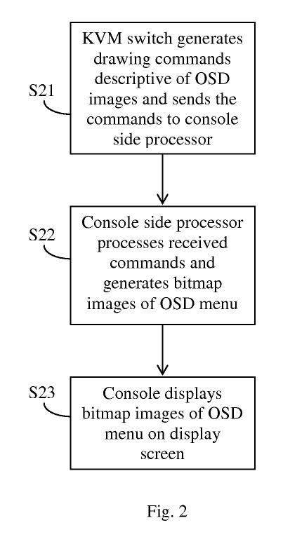

In an on-screen display (OSD) image generating method according to an embodiment of the present invention, as schematically illustrated in FIG. 2, the KVM switch 13 generates drawing commands (a command may include various data as a part of the command) descriptive of OSD images, and transmits the drawing commands to the console side processor (strep S21). The various data may include vector graphic data, text data, and bitmap image data, but it does not include a bitmap representing the entire OSD image. The console side processor processes the received drawing commands and generates image data representative of the OSD images based on the drawing commands (step S22). The OSD image data is raster data in nature, and is in an appropriate format for the display hardware of the monitor 11a. For example, the OSD image data may be video data in the RGB format, or video data in the composite video format, etc. From the standpoint of the display hardware of the monitor 11a, the OSD image data is preferably the same as the OSD image data received by the monitor in a conventional KVM system. The OSD image data is then displayed by the monitor 11a (step S23).

In addition to the steps described above, the console side processor may store on the console side resources useful in generating OSD images. Such resources may include text data, vector graphic data, bitmap image data, etc. The resources are transmitted from the KVM switch 13 to the console side once, and are stored in and managed by the console side processor for future use. These resources are later used to generate OSD images by the console side processor based on drawing commands received from the KVM switch 13. For example, the KVM switch 13 may transmit text, graphics or image data representing an icon to the console side processor, where the icon is identified by a resource identifier. The data representing the icon is stored on the console side. Later, the KVM switch 13 may transmit a drawing command to the console side processor referring to the particular resource identifier, and the console side processor draws the icon using the stored resource. The console side processor may also send requests to the KVM switch 13 to request particular resources. For example, if the console side processor receives a drawing command that refers to a resource identifier for an icon, but the console side processor has not already received that resource from the KVM switch 13, the console side processor sends a request to the KVM switch to request the resource.

Further, the drawing commands may include macros, each macro representing a series of drawing commands. For example, a macro may represent a series of commands that draw an icon and certain text associated with the icon. The KVM switch 13 may transmit a series of drawing commands to the console side processor, and instructs the console side processor to define the series of drawing commands as a macro which is identified by a macro identifier. The macros are stored on the console side and managed by the console side processor. Later, the KVM switch 13 may transmit a drawing command to the console side processor referring to the macro identifier, and the console side processor executes the series of drawing commands represented by that macro to draw the images.

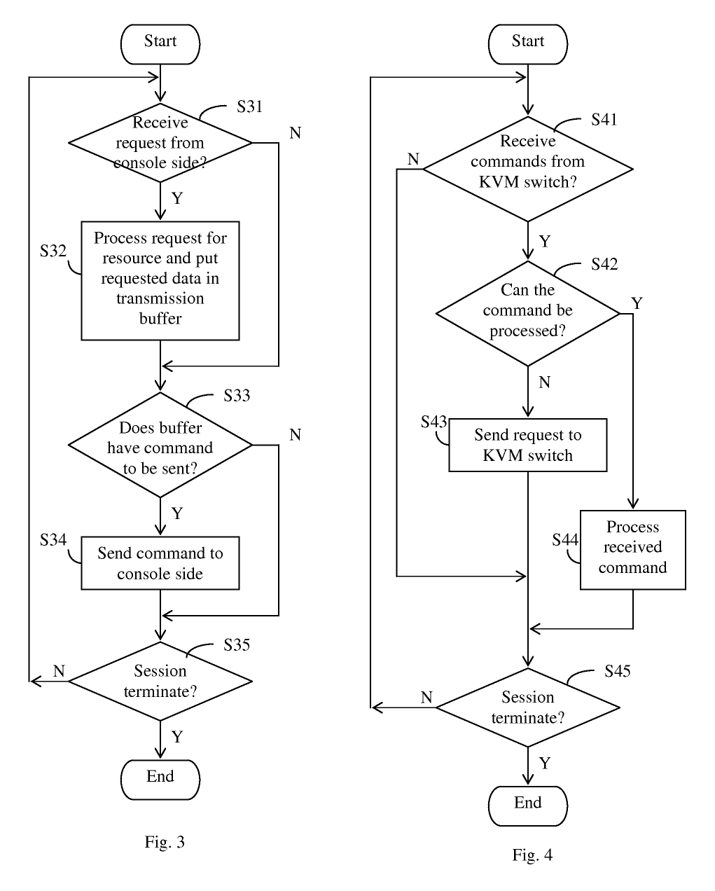

FIGS. 3 and 4 illustrate the interactions between the KVM switch 13 and the console side processor for the generation and display of OSD images. The process shown in FIG. 3 is implemented in the KVM switch 13 and the process shown in FIG. 4 is implemented in the console side processor. Of course, the KVM switch and the console side also execute other processes, such as a process for establishing communication with each other; these processes are not shown in FIGS. 3 and 4. As shown in FIG. 3, the KVM switch 13 determines whether a request for resource has been received from the console side processor (step S31). As mentioned earlier, the console side processor may request resources from the KVM switch. If such a request is received (“Y” in step S31), the KVM switch 13 processes the request and puts the requested resource in a transmission buffer (step S32).

After step S32, or if no request for resources from the console side processor is received (“N” in step S31), the KVM switch 13 determines whether the transmission buffer contains any drawing command to be transmitted to the console side processor (step S33). A separate process executed by the KVM switch 13 (not shown in FIG. 3) generates drawing commands for drawing the OSD image, and puts them in the transmission buffer, in addition to the data generated in response to a console side request in step S32. If the buffer contains drawing commands to be transmitted (“Y” in step S33), the KVM switch 13 transmits the drawing commands to the console side processor (step S34). After the transmission, or if the buffer does not contain drawing commands to be transmitted (“N” in step S33), the KVM switch 13 determines whether the OSD session is terminated (step S35). The OSD session may be terminated by various events; for example, the user may exit the OSD process after switching the user console 11 to one of the computers 12. The process ends if the OSD session has terminated (“Y” in step S35); otherwise (“N” in step S35), it goes back to step S31.

As shown in FIG. 4, the console side processor determines whether any drawing commands have been received from the KVM switch 13 (step S41). If yes (“Y” in step S41), the console side processor determines whether the received drawing commands can be processed (step S42). For example, as described earlier, if a received drawing command refers to a resource that is not available on the console side, the console side processor will not be able to process the drawing command. In such cases (“N” in step S42), the console side processor sends a request for resource to the KVM switch 13 to request the needed resource (step S43). If the received drawing commands can be processed (“Y” in step S42), the console side processor processes the received commands (step S44). The processing step S44 may include, for example, processing and storing resources if the command received in step S41 includes resources, which may be sent from the KVM switch 13 in response to a previous request by the console side processor in step S43. This processing step may also include generating the OSD image or a part thereof based on the command, and displaying the OSD image on the display device of the console. Note that generating a complete OSD image may require receiving and processing multiple drawing commands, i.e., repeating steps S41-S44 multiple times. After steps S43 and S44, or if no drawing commands are received in step S41 (“N” in step S41), the process goes back to step S41 (“N” in step S45) unless the OSD session has terminated (“Y” in step S45).

Tables 1 and 2 below present exemplary program code of programs executed by the KVM switch (server) and the console side processor (client), respectively. It should be understood that they are only examples and the invention is not limited to any particular software implementation.

TABLE 1
// Server
void DrawIcon(int nID, int nLeft, int nTop, int nRight, int nBottom, char *
lpBuf)
{

| char *pBuf = lpBuf; | | |
|---|---|---|
| *(pBuf+2) = OSD_RESOURCE_VERSION; | | // set resource |
| | | version |
| *(pBuf+3) = OSD_DRAWICON_PACKET; | | // draw icon |
| | | command |
| *(pBuf+4) = (nID | >> 8) & 0xFF; | |
| *(pBuf+5) = (nID | ) & 0xFF; | // resource ID |

| | | |
|---|---|---|
| *(pBuf+6) = (nLeft | >> 8) & 0xFF | |
| *(pBuf+7) = (nLeft | ) & 0xFF | // left |
| *(pBuf+8) = (nTop | >> 8) & 0xFF | |
| *(pBuf+9) = (nTop | ) & 0xFF | // top |
| *(pBuf+10)= (nRight | >> 8) & 0xFF | |
| *(pBuf+11)= (nRight | ) & 0xFF | // right |
| *(pBuf+10)= (nBottom | >> 8) & 0xFF | |
| *(pBuf+11)= (nBottom | ) & 0xFF | // bottom |
| *(pBuf )= 0; | | |
| *(pBuf+1 )= 12; | | // packet length |

```
}
void SendReourceByID(int nID, char * lpBuf)
{
    int  nLen = 0;
    char *pBuf = lpBuf;
    char *pRes = FindResourceByID(nID, &nLen);
```

| | |
|---|---|
| *(pBuf+2) = OSD_RESOURCE_VERSION; | // set resource |
| | version |
| *(pBuf+3) = OSD_RESOURCE_PACKET; | |

| | | |
|---|---|---|
| *(pBuf+4) = (nID | >> 8) & 0xFF; | |
| *(pBuf+5) = (nID | ) & 0xFF; | // resource ID |

| | | |
|---|---|---|
| *(short *)(pBuf+6) = (nLen | >> 8) & 0xFF; | |
| *(short *)(pBuf+7) = (nLen | ) & 0xFF; | // resource length |

```
    if ( pRes ) {
        memcpy(pBuf+8, pRes, nLen);
    }
    nLen = nLen + 6;
    *pBuf  = (nLen >> 8) & 0xFF;
```

| | |
|---|---|
| *(pBuf+1) = (nLen ) & 0xFF; | // packet length |

TABLE 2
// Client
void SendRequest(int nID)
{
char pBuf[16];

| | |
|---|---|
| *(pBuf+2) = OSD_RESOURCE_VERSION; | // set resource |
| | version |
| *(pBuf+3) = OSD_REQUEST_PACKET; | |

| | | |
|---|---|---|
| *(pBuf+4) = (nID | >> 8) & 0xFF; | |
| *(pBuf+5) = (nID | ) & 0xFF; | // resource ID |
| *(pBuf )= 0; | | |

| | |
|---|---|
| *(pBuf+1 )= 4; | // packet length |
| Send(pBuf, 6); | |

```
}
void Proc(char * lpBuf)
{
    int nCmd;
    int nID;
    int nLen;
    int nLeft, nRight, nTop, nBottom;
    char * pRes;
    char * lpRBuf;
    int  nRes;
    nCmd = *(lpBuf + 3);
    nID = (*(lpBuf + 4) << 8) | *(lpBuf + 5);
    switch ( nCmd ) {
        case OSD_DRAWICON_PACKET
```

| | |
|---|---|
| nLeft | = (*(lpBuf + 6) <<8) \| *(lpBuf + 7); |
| nTop | = (*(lpBuf + 8) <<8) \| *(lpBuf + 9); |
| nRight | = (*(lpBuf + 10) <<8) \| *(lpBuf + 11); |
| nBottom | = (*(lpBuf + 12) <<8) \| *(lpBuf + 13); |

```
            pRes = FindResourceByID(nID, &nLen);
            if ( pRes == 0 ) {
                // Send request command
                SendRequest (nID);
                // Get resource from server
                lpRBuf = Recv(&nRes);
                if ( nRes > 0 ) {
                    nLen = (*(lpRBuf + 6) << 8) | *(lpRBuf + 7);
                    if ( nLen ) {
                        AddResource(nID, lpRBuf+8, nLen);
                        pRes = FindResourceByID(nID, &nLen);
                    }
                }
            }
            if ( pRes ) {
                DrawIcon(nLeft, nRight, nTop, nBottom, pRes, nLen);
            }
            else {
                HandleError (nID);
            }
            break;
    }
}
```

By transmitting drawing commands from the KVM switch to the console side and generating OSD images at the console side, the OSD generating method described above has the advantages of being highly modular, fast and portable.

Although a KVM switch system (FIGS. 1a-1c) is used as an example in the above detailed descriptions, the OSD generating method according to embodiments of the present invention may also be implemented on any server-client system, generally shown in FIG. 1d. The connection between the server 14 and client 15 can be any kind of connection, including via a network. In such a system, the server 14 performs the functions performed by the KVM switch 13 and the client 15 performs the functions performed by the console side processor in the example of FIGS. 1a-1d. More generally, the KVM switch 13 in FIGS. 1a-1c can be referred to as a server and the console side (including the console side device 17 and the console module 19 as appropriate) can be referred to as a client. Thus, the term “server” should be broadly understood to refer to a KVM switch 13 or any other server 14, and the term “client” should be broadly understood to refer to the console side or any other client 15.

As pointed out earlier, in conventional methods of generating OSD display, different KVM switches may require different consoles or different console software to ensure that the KVM switch and the console can correctly cooperate with each other. Further, the KVM switch may be required to perform different calculation for different consoles. Embodiments of the present invention provide a universal method for OSD image generation. Using such methods according to embodiments of the present invention, the console side processor only has to interpret and execute OSD drawing commands from the KVM switch. This allows the same console side structure to be used with different KVM switch systems. For the same KVM switch, different consoles can display the same user interface display, even on consoles systems that run under different operating systems. The KVM switch sends the same drawing commands to different console side processors regardless of the console hardware requirements such as the monitor resolution. Another advantage of the OSD generating method according to embodiments of the present invention is the reduced memory demand on the KVM switch. The conventional method that transmits compressed OSD images from the KVM switch to the console requires large memory capacity for the KVM switch to support concurrent multiple users.

It will be apparent to those skilled in the art that various modification and variations can be made in the OSD generating method of the present invention without departing from the spirit or scope of the invention. Thus, it is intended that the present invention cover modifications and variations that come within the scope of the appended claims and their equivalents.

What is claimed is:

1. A method implemented in a keyboard, video, mouse (KVM) switch system for generating an on-screen display (OSD) image, the KVM switch system including a KVM switch and a console side system connected to the switch, the console side system including a console side process and a user console which includes a monitor, the method comprising:
the KVM switch transmitting drawing commands descriptive of OSD images to the console side processor;
the console side processor processing the drawing commands received from the KVM switch to generate images for OSD; and
the console side processor displaying the images for OSD on the monitor of the user console.

2. The method of claim 1, wherein the drawing commands include vector graphic data, text data, and bitmap image data.

3. The method of claim 1, further comprising:
the KVM switch transmitting a resource to the console side processor, the resource being associated with a resource identifier;
the console side processor storing the resource with the associated resource identifier;
the KVM switch transmitting a drawing command referring to the resource identifier; and
the console side processor processing the drawing command and generating images for OSD using the resource associated with the resource identifier.

4. The method of claim 1, further comprising:
the KVM switch transmitting a series of commands and a macro identifier to the console side processor;
the console side processor storing the series of commands as a macro associated with the macro identifier;
the KVM switch transmitting a drawing command referring to the macro identifier; and
the console side processor processing the drawing command and generating images for OSD using the series of commands of the macro associated with the macro identifier.

5. The method of claim 1, further comprising:
the console side processor transmitting a request to the KVM switch requesting data;
the KVM switch transmitting data to the console side processor in response to the request; and
the console side processor processing the data received from the KVM switch and generating images for OSD using the data.

6. The method of claim 1, wherein the KVM switch and the console side system are connected by a dedicated connection.

7. The method of claim 1, wherein the KVM switch and the console side system are connected by a network.

8. In a keyboard, video, mouse (KVM) switch system including a KVM switch and a console side system connected to the switch, a method implemented in the KVM switch, comprising:
generating drawing commands descriptive of on-screen display (OSD) images; and
transmitting the drawing commands to the console side system.

9. The method of claim 8, wherein the drawing commands include vector graphic data, text data, and bitmap image data.

10. The method of claim 8, further comprising:
transmitting a resource to the console side system, the resource being associated with a resource identifier; and
transmitting a drawing command to the console side system referring to the resource identifier.

11. The method of claim 8, further comprising:
transmitting a series of commands and a macro identifier to the console side system; and
transmitting a drawing command to the console side system referring to the macro identifier.

12. The method of claim 8, further comprising:
receiving a request from the console side system requesting data; and
transmitting data to the console side system in response to the request.

13. The method of claim 8, wherein the KVM switch and the console side system are connected by a dedicated connection.

14. The method of claim 8, wherein the KVM switch and the console side system are connected by a network.

15. In a keyboard, video, mouse (KVM) switch system including a KVM switch and a console side system connected to the switch, the console side system including a console side processor and a user console that includes a monitor, a method implemented in the console side processor, comprising:
receiving from the KVM switch drawing commands descriptive of on-screen display (OSD) images;
processing the received drawing commands to generate images for OSD; and
displaying the images for OSD on the monitor of the user console.

16. The method of claim 15, wherein the drawing commands include vector graphic data, text data, and bitmap image data.

17. The method of claim 15, further comprising:
receiving a resource from the KVM switch, the resource being associated with a resource identifier;
storing the resource with the associated resource identifier;
receiving from the KVM switch a drawing command referring to the resource identifier; and
processing the drawing command and generating images for OSD using the resource associated with the resource identifier.

18. The method of claim 15, further comprising:
receiving from the KVM switch a series of commands and a macro identifier;
storing the series of commands as a macro associated with the macro identifier;
receiving from the KVM switch a drawing command referring to the macro identifier; and
processing the drawing command and generating images for OSD using the series of commands of the macro associated with the macro identifier.

19. The method of claim 15, further comprising:
transmitting a request to the KVM switch requesting data;
receiving from the KVM switch data in response to the request; and
processing the data received from the KVM switch and generating images for OSD using the data.

20. The method of claim 15, wherein the KVM switch and the console side system are connected by a network.
